(19) United States
(12) Patent Application Publication
(10) Pub. No.: US 2008/0046303 A1
(43) Pub. Date: Feb. 21, 2008

(54) METHOD AND SYSTEM OF DETERMINING ELEMENTS OF A VALUE PRICED CONTRACT

(76) Inventors: Penelope E. Gordon, Alameda, CA (US); Paul G. Greenstein, Croton-on-Hudson, NY (US); Ann M. Gruhn, Mount Kisco, NY (US); David J. Smith, Ridgefield, CT (US)

Correspondence Address: HOFFMAN, WARNICK & D'ALESSANDRO LLC, 75 STATE ST, 14TH FLOOR, ALBANY, NY, 12207, US

(21) Appl. No.: 11/465,923

(22) Filed: Aug. 21, 2006

(51) Int. Cl. G06Q 10/00; G06F 15/02; G06Q 30/00

(52) U.S. Cl. 705/9; 705/1

(57) ABSTRACT

The invention provides a solution for managing a business engagement between a provider and a client. The business engagement relates business value of a client to practices of a provider to determine elements of a value priced contract. The invention obtains prioritized business requirements and maps them to priorities that are used to derive metrics, which can be inputted into a proposed contract. Furthermore, client empirical data and/or provider empirical data can be used during contract generation. The invention may further perform the aforementioned mapping by examining efficiency, effectiveness, alignment, and/or transformation metrics of the provider and/or the client. The invention may further determine apportionment of value and risk between the client and the provider for each resulting element determined. In this manner, the invention provides an improved solution for managing a business engagement by comparing client/provider capabilities and selecting elements to include in the contract.

### FIELD OF THE INVENTION

The invention relates generally to a method and system for determining elements of a value priced service contract, and more particularly, to a method and system for relating business value of a product or service to a client to practices of a provider.

### BACKGROUND OF THE INVENTION

Value pricing is a method of pricing a product or service whereby the payment terms agreed upon by the client and the provider (prior to the completion of the sales transaction) are based on the business value that the client expects to derive from the product or service.

From the client's perspective, value pricing is advantageous because it does not need to be converted to quantify the opportunity cost of a procurement. This is because portfolio management techniques to determine opportunity costs use relative weighting of investment choices assigned on the basis of business value. Plus, chargebacks are also easier with value pricing since presumably all units of a client company use common parameters in measuring value.

By engaging with a client using a vocabulary that is integral to the client's culture, the provider can have a meaningful conversation with any unit of the client company about the service or product, including service level negotiations. Further, the provider can use this common language to engage the client in a dialogue regarding business value with the goal of validating that the stated values are truly reflective of the client's needs.

A provider has a collection of known best practices for service/product delivery and standard measurements. Each client has a unique collection of important business value statements. One problem is how to structure a value pricing contract, given that the provider and the client do not have the same semantics. In other words, one problem is how to translate between best practices and business value, for the purposes of structuring a contract.

In view of the foregoing, there exists a need in the art to overcome one or more of the deficiencies indicated herein.

### SUMMARY OF THE INVENTION

The invention provides a solution for managing a business engagement between a provider and a client. The business engagement relates business value of a client to practices of a provider to determine elements of a value priced contract. The invention obtains prioritized business requirements and maps them to priorities that are used to derive metrics, which can be inputted into a proposed contract. Furthermore, client empirical data and/or provider empirical data can be used during contract generation. The invention may further perform the aforementioned mapping by examining efficiency, effectiveness, alignment, and/or transformation metrics of the provider and/or the client. The invention may further determine apportionment of value and risk between the client and the provider for each resulting element determined. In this manner, the invention provides an improved solution for managing a business engagement by comparing client/provider capabilities and selecting elements to include in the contract.

A first aspect of the invention provides a method of managing a business engagement, the method comprising: obtaining a provider delivery metric and a client metric; obtaining a set of resulting elements relevant to a provider and a client, wherein the set of resulting elements is based on the provider delivery metric and the client metric; obtaining an advantage value for each of the set of resulting elements; and selecting at least one of the set of resulting elements to be included in the business engagement based on the advantage value.

A second aspect of the invention provides a system for managing a business engagement, the system comprising: a system for obtaining a provider delivery metric and a client metric; a system for obtaining a set of resulting elements relevant to a provider and a client, wherein the set of resulting elements is based on the provider delivery metric and the client metric; a system for obtaining an advantage value for each of the set of resulting elements; and a system for selecting at least one of the set of resulting elements to be included in the business engagement based on the advantage value.

A third aspect of the invention provides a program product stored on a computer-readable medium, which when executed, enables a computer infrastructure to manage a business engagement, the program product comprising computer program code for enabling the computer infrastructure to: obtain a provider delivery metric and a client metric; obtain a resulting metric that identifies a set of resulting elements relevant to a provider and a client, wherein the resulting metric is based on the provider delivery metric and the client metric; obtain an advantage value for each of the set of resulting elements; and select at least one of the set of resulting elements to be included in the business engagement based on the advantage value.

A fourth aspect of the invention provides a method of generating a system for managing a business engagement, the method comprising: providing a computer infrastructure operable to: obtain a provider delivery metric and a client metric; obtain a resulting metric that identifies a set of resulting elements relevant to a provider and a client, wherein the resulting metric is based on the provider delivery metric and the client metric; obtain an advantage value for each of the set of resulting elements; and select at least one of the set of resulting elements to be included in the business engagement, wherein the selection is based on the advantage value.

A fifth aspect of the invention provides a business method for managing a business engagement, the business method comprising managing a computer infrastructure that performs the process of the invention; and receiving payment based on the managing.

The illustrative aspects of the present invention are designed to solve one or more of the problems herein described and/or one or more other problems not discussed.

### BRIEF DESCRIPTION OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a business engagement between a provider and a client according to an embodiment of the invention.

FIG. 2 shows an illustrative process that can be implemented by the environment of FIG. 1 according to an embodiment of the invention.

FIG. 3 shows an intersection of the provider metric and the client metric in four illustrative areas.

FIG. 4 shows an illustrative provider metric according to an embodiment of the invention.

FIG. 5 shows an illustrative client metric according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The invention provides a solution for managing a business engagement between a provider and a client. The business engagement relates business value of a client to practices of a provider to determine elements of a value priced contract. The invention obtains prioritized business requirements and maps them to priorities that are used to derive metrics, which can be inputted into a proposed contract. Furthermore, client empirical data and/or provider empirical data can be used during contract generation. The invention may further perform the aforementioned mapping by examining efficiency, effectiveness, alignment, and/or transformation metrics of the provider and/or the client. The invention may further determine apportionment of value and risk between the client and the provider for each resulting element determined. In this manner, the invention provides an improved solution for managing a business engagement by comparing client/provider capabilities and selecting elements to include in the contract. As used herein, unless otherwise noted, the term “set” means one or more (i.e., at least one).

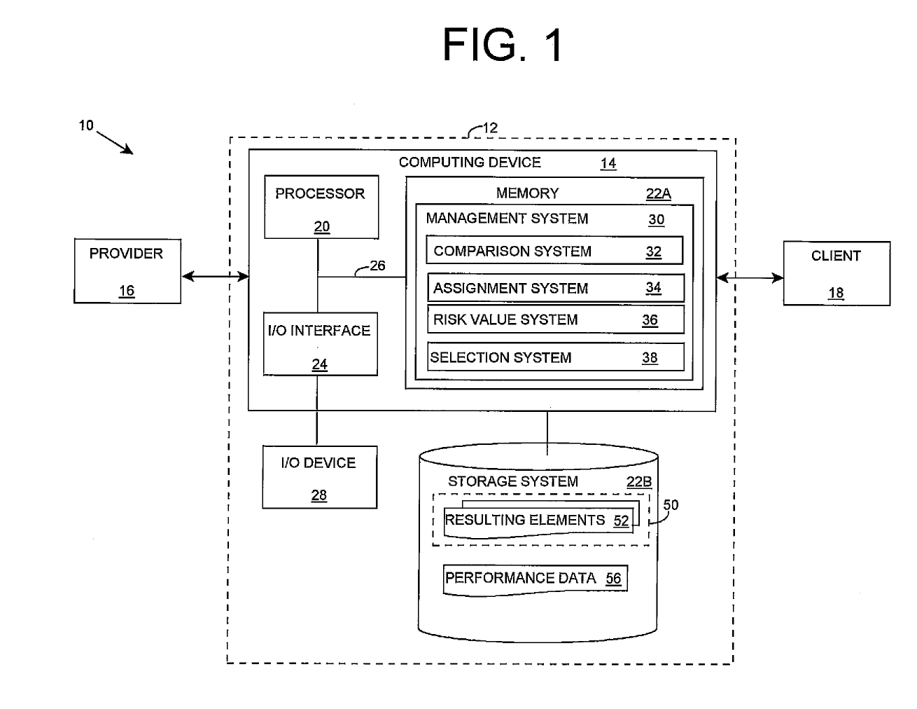

Turning to the drawings, FIG. 1 shows an illustrative environment 10 for managing a business engagement 50 according to an embodiment of the invention. To this extent, environment 10 includes a computer infrastructure 12 that can perform the process described herein in order to manage business engagement 50. In particular, computer infrastructure 12 is shown including a computing device 14 that comprises a management system 30, which makes computing device 14 operable to manage business engagement 50 by performing the process described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as management system 30, which is stored in memory 22A and/or storage system 22B. While executing computer program code, processor 20 can read and/or write data, such as business engagement 50, to/from memory 22A, storage system 22B, and/or I/O interface 24. Bus 26 provides a communications link between each of the components in computing device 14. I/O device 28 can comprise any device that enables an individual to interact with computing device 14 or any device that enables computing device 14 to communicate with one or more other computing devices using any type of communications link.

In any event, computing device 14 can comprise any general purpose computing article of manufacture capable of executing computer program code installed thereon (e.g., a personal computer, server, handheld device, etc.). However, it is understood that computing device 14 and management system 30 are only representative of various possible equivalent computing devices that may perform the process described herein. To this extent, in other embodiments, the functionality provided by computing device 14 and management system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed herein, management system 30 enables computer infrastructure 12 to manage a business engagement 50. To this extent, management system 30 is shown including a comparison system 32, an assignment system 34, a risk value system 36, and a selection system 38. Operation of each of these systems is discussed further herein. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of computer infrastructure 12.

Regardless, the invention provides a solution for managing business engagement 50 between provider 16 and client 18. In general, business engagement 50 includes a set of resulting elements 52 stored in memory 22A and/or storage system 22B, each of which are relevant to provider 16 (or a related entity) and to client 18 as part of business engagement 50. The set of resulting elements 52 can comprise goods (e.g., a new product purchase), services (e.g., information technology management), or some combination thereof.

Management system 30 can manage business engagement 50 throughout the evaluation, proposal, contractual, delivery, and performance lifecycles of business engagement 50. The invention as described herein assumes that business engagement 50 results in a contractual agreement between provider 16 and client 18. However, it is understood that business engagement 50 may be at any of the various stages in the lifecycle, and business engagement 50 may or may not result in a contractual agreement and performance by provider 16. Further, business engagement 50 can include additional data, such as an identification of provider 16 and/or client 18, a status of the engagement, and/or the like. Still further, it is understood that management system 30 can be utilized by provider 16, client 18, and/or a third party user to manage business engagement 50.

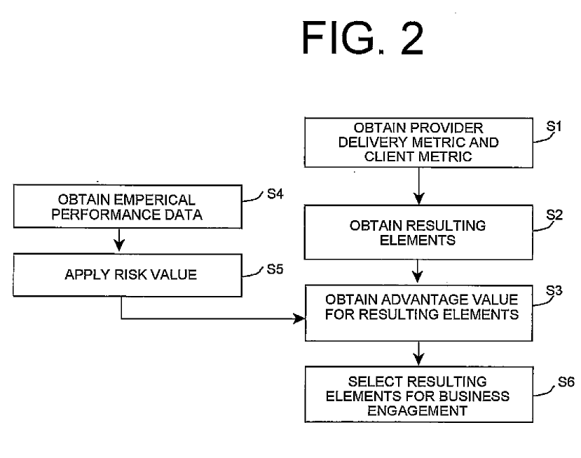

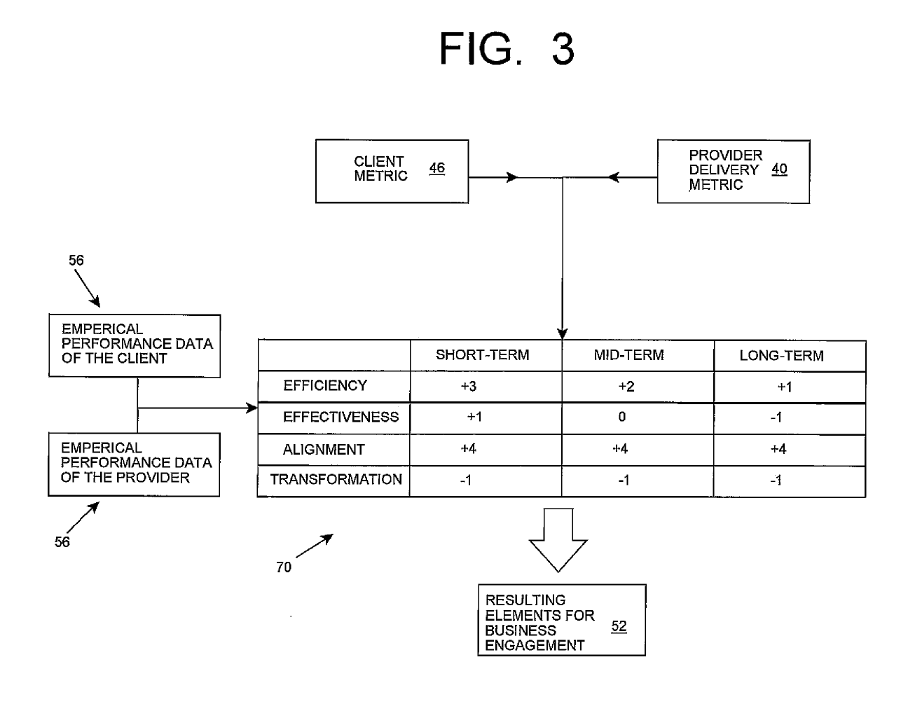

FIG. 2 shows an illustrative process that can be implemented by environment 10 (FIG. 1) according to an embodiment of the invention, and FIG. 3 shows an illustrative provider metric according to an embodiment of the invention. Referring to FIGS. 1-3, in step S1, comparison system 32 obtains provider delivery metric 40 and client metric 46. Comparison system 32 can obtain delivery metric 40 and client metric 46 using any known solution. For example, a user, such as provider 16 and/or client 18, can identify, define, and/or provide metrics 40, 46 to comparison system 32. In one embodiment, the user comprises an individual, and comparison system 32 generates a user interface for presentation to the user, which enables the user to identify, define, modify, view, delete, and/or the like each metric 40, 46. In this case, comparison system 32 can provide the user interface for presentation to the user on an I/O device 28 and/or over a network such as the Internet. Alternatively, the user can comprise another system and comparison system 32 can support an Application Program Interface (API) or the like that enables the user to perform the various operations with respect to the metric(s) 40, 46.

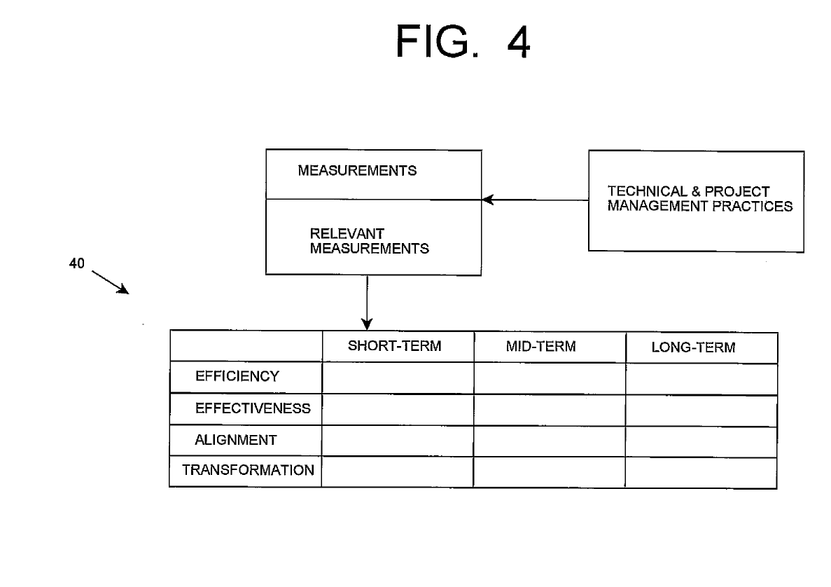

Comparison system 32 can use provider delivery metric 40 and client metric 46 to identify and/or categorize a set of measurements for provider 16 and client 18. As shown in FIG. 4, provider delivery metric 40 can comprise a set of performance categories (e.g., efficiency, effectiveness, alignment, transformation) representing capabilities of provider 16 evaluated over a range of time periods (e.g., short-term, mid-term, and long-term). Using as an example, an application development and maintenance services business, provider delivery metric 40 takes a list of provider's delivery measurements and generates a subset that includes those relevant to delivery practices (e.g., relevant measurements). In this case, a defect-related measurement could stay in the set of relevant measurements, as it relates to the practice of problem tracking and reporting. However, a labor utilization measurement may not, as it may not relate to technical delivery practices.

As shown in FIG. 4, the set of performance categories is subset into four areas: efficiency, effectiveness, alignment, and transformation. In this example, technical and project management practices are measured and then evaluated based on each of the four categories. The resulting provider delivery metric 40 represents a collection of the associated measurements and a summary of the value of what the provider delivers. The performance categories represent the four value aspects of application development and maintenance. Furthermore, provider delivery metric 40 evaluates the short/mid/long-term applicability of each category.

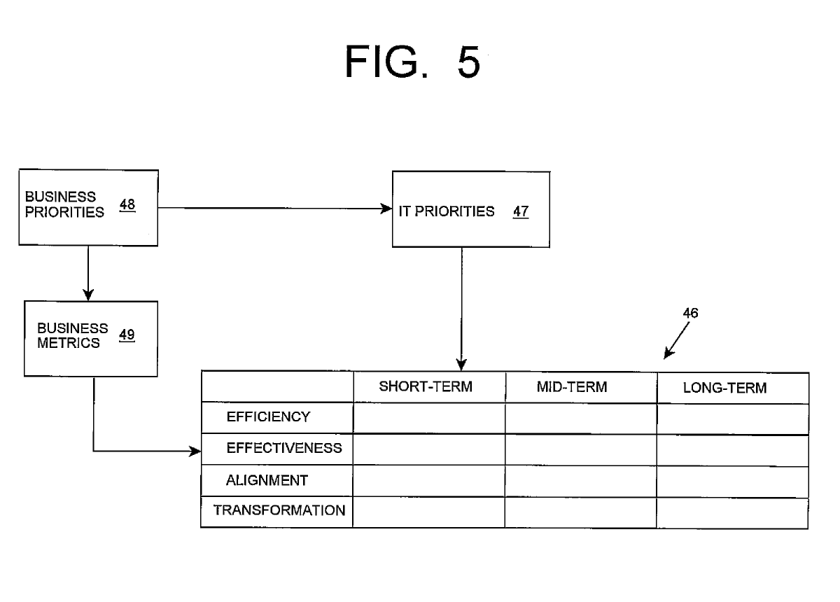

As shown in FIG. 5, client metric 46 can comprise a set of performance categories representing capabilities of the client evaluated over a range of time periods. In this embodiment, the set of performance categories are derived from a set of information technology (IT) priorities 47 of client 18. Similar to the process described herein with respect to provider delivery metric 40, the set of performance categories is subset into four areas: efficiency, effectiveness, alignment, and transformation. However, with client metric 46, the set of IT priorities 47 of the client are measured and then evaluated based on each of the four categories. IT priorities 47 are based on a set of business priorities 48 of the client. The resulting client metric 46 represents a collection of the associated measurements and a summary of the value of what the client needs/desires. Client metric 46 is further validated against a previously defined business metric(s) 49, that measures an attainment of business priorities of client 18.

Referring to FIGS. 1-3, in step S2, comparison system 32 obtains a set of resulting elements 52 relevant to provider 16 and client 18, wherein the set of resulting elements 52 is based on provider delivery metric 40 and client metric 46. The intersection of provider delivery metric 40 with client metric 46 produces resulting metric 70. By comparing provider delivery metric 40 with client metric 46, resulting metric 70 is obtained, which identifies a set of resulting elements 52 relevant to the provider and the client. The set of resulting elements 52 represents what provider 16 delivers that client 18 needs/desires, which can be measured and used during business engagement 50. The intersection of the two metrics 40, 46 in four areas (efficiency, effectiveness, alignment, and transformation), identifies the resulting elements 52 to be included in the contract. As further discussed herein, by comparing provider delivery metric 40 with client metric 46, it is possible to determine whether provider 16 performs better or worse than client 18 for a particular performance category.

In step S3, assignment system 34 obtains an advantage value for each of the set of resulting elements 52. Assigning an advantage value includes determining whether provider 16 performs better than client 18. For example, the advantage value can represent the measurable benefit to client 18 when provider 16 produces a service, compared to the client's way of performing the same service in-house. Referring to FIG. 3, a representative set of advantage values is shown as it relates to resulting metric 70. As shown, the advantage value(s) for each performance category is represented as a numerical integer ranging in value between −5 and +5. A positive (+) number represents a measurable benefit to client 18, while a negative (−) number indicates that provider 16 fails to perform better than client 18. However, it should be understood that the advantage value(s) may be quantified in a variety of ways.

In one embodiment, this determination is based on empirical performance data 56 of provider 16 and client 18, as shown in FIG. 2, step S4 and FIG. 3. For example, each performance category for client 18 and/or provider 16 can include historical data from previous projects. Assignment system 34 can obtain empirical performance data 56 using any solution. For example, assignment system 34 can receive empirical performance data 56 from another system (e.g., client 18), assignment system 34 can generate a user interface that enables provider 16 and/or client 18 to enter empirical performance data 56, and/or the like. Additionally, assignment system 34 can receive empirical performance data 56 from a third party user, which provides benchmarking data or the like, on client 18 and/or provider 16. Therefore, by comparing the current capabilities of provider 16 with the current capabilities of client 18, and considering empirical data 56, areas for improvement can be identified and assigned a value based on an advantage to client 18.

In step S5, risk value system 36 can assign a risk value to the advantage value based on empirical performance data 56 of provider 16 and/or client 18. For example, based on empirical performance data 56 of provider 16, a risk value is applied to the advantage value, wherein the advantage value represents the measurable benefit to client 18 when provider 16 produces a good/service, compared to the client's way of producing/performing the same good/service in-house. The risk value can be expressed as a percentage (%) or a probability. A user, such as provider 16, can provide an individual provider risk preference level for each performance category, apply an individual provider risk preference level to each advantage value, and/or provide a provider risk preference level for a set of resulting elements 52. In any event, the provider risk preference level can be based on any of numerous considerations for provider 16. For example, provider 16 may desire a predictable payment for implementing business solution(s) 52. Depending on the terms of the contract and whether risk sharing is desired as part of the value pricing contract, the risk value can be apportioned between the client and the provider. In this case, provider 16 may not desire to share risk with client 18 in exchange for lower initial payments. Accordingly, in step S6, selection system 38 selects at least one of the set of resulting elements 52 for inclusion in business engagement 50 based on the advantage value, wherein the advantage value incorporates empirical results and an allocation of risk.

In one embodiment, the invention provides an improved solution for quantifying the opportunity cost of business engagement 50 based on the business value that client 18/provider 16 expects to derive from the product or service. By assigning an advantage value to each of the set of resulting elements, management system 30 determines an opportunity cost(s) using relative weighting of investment choices assigned on the basis of business value. The present invention quantifies the value of business engagement 50 as a whole, as well as the value of each various element. Accordingly, a value pricing contract may be structured to maximize business value to client 18, while apportioning the amount of risk client 18 and provider 16 can reasonably undertake in the identified areas.

While shown and described herein as a method and system for managing a business engagement, it is understood that the invention further provides various alternative embodiments. For example, in one embodiment, the invention provides a program product stored on a computer-readable medium, which when executed, enables a computer infrastructure to manage a business engagement. To this extent, the computer-readable medium includes program code, such as management system 30 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), as a data signal traveling over a network (e.g., during a wired/wireless electronic distribution of the program product), and/or the like.

In another embodiment, the invention provides a method of generating a system for managing a business engagement. In this case, a computer infrastructure, such as computer infrastructure 12 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process of the invention.

In still another embodiment, the invention provides a business method that performs the process described herein on a subscription, advertising, and/or fee basis. That is, a service provider, such as a Solutions Integrator, could offer to manage a business engagement as described herein. In this case, the service provider can manage (e.g., create, maintain, support, etc.) a computer infrastructure, such as computer infrastructure 12 (FIG. 1), that performs the process described herein for one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or IPO device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a business engagement, the method comprising:
obtaining a provider delivery metric and a client metric;
obtaining a set of resulting elements relevant to a provider and a client, wherein the set of resulting elements is based on the provider delivery metric and the client metric;
obtaining an advantage value for each of the set of resulting elements; and
selecting at least one of the set of resulting elements to be included in the business engagement based on the advantage value.

2. The method of claim 1, further comprising comparing the provider delivery metric with the client metric to obtain a resulting metric that identifies the set of resulting elements.

3. The method of claim 1, wherein the obtaining an advantage value includes determining whether the provider performs better than the client.

4. The method of claim 3, wherein the determining is based on empirical performance data.

5. The method of claim 4, further comprising assigning a risk value to the advantage value based on the empirical performance data.

6. The method of claim 1, wherein the provider delivery metric comprises a set of performance categories representing capabilities of the provider evaluated over a range of time periods.

7. The method of claim 1, wherein the client metric comprises a set of performance categories representing capabilities of the client evaluated over a range of time periods.

8. The method of claim 7, wherein the set of performance categories is based on a set of information technology (IT) priorities of the client.

9. The method of claim 8, wherein the set of IT priorities is based on a set of business priorities of the client.

10. A system for managing a business engagement, the system comprising:
a system for obtaining a provider delivery metric and a client metric;
a system for obtaining a set of resulting elements relevant to a provider and a client, wherein the set of resulting elements is based on the provider delivery metric and the client metric;
a system for obtaining an advantage value for each of the set of resulting elements; and
a system for selecting at least one of the set of resulting elements to be included in the business engagement based on the advantage value.

11. The system of claim 10, further comprising a system for comparing the provider delivery metric with the client metric to obtain a resulting metric that identifies the set of resulting elements.

12. The system of claim 10, wherein the system for obtaining an advantage value determines whether the provider performs better than the client.

13. The system of claim 12, wherein the determination is based on empirical performance data of at least one of the provider and the client.

14. The system of claim 13, further comprising a system for assigning a risk value to the advantage value based on the empirical performance data.

15. The system of claim 10, wherein the provider delivery metric comprises a set of performance categories representing capabilities of the provider evaluated over a range of time periods.

16. The system of claim 10, wherein the client metric comprises a set of performance categories representing capabilities of the client evaluated over a range of time periods.

17. The system of claim 16, wherein the set of performance categories is based on a set of information technology (IT) priorities of the client.

18. The system of claim 17, wherein the set of IT priorities is based on a set of business priorities of the client.

19. A program product stored on a computer-readable medium, which when executed, enables a computer infrastructure to manage a business engagement, the program product comprising computer program code for enabling the computer infrastructure to:
obtain a provider delivery metric and a client metric;
obtain a resulting metric that identifies a set of resulting elements relevant to a provider and a client, wherein the resulting metric is based on the provider delivery metric and the client metric;
obtain an advantage value for each of the set of resulting elements; and
select at least one of the set of resulting elements to be included in the business engagement based on the advantage value.

20. The program product of claim 19, wherein the computer program code for enabling the computer infrastructure to obtain an advantage value enables the computer infrastructure to determine whether the provider performs better than the client based on empirical performance data.

21. The program product of claim 20, further comprising computer program code for enabling the computer infrastructure to apply a risk value to each advantage value based on the empirical performance data.

22. The program product of claim 19, wherein the computer program code for enabling the computer infrastructure to obtain a provider delivery metric and a client metric enables the computer infrastructure to obtain a set of performance categories for the provider delivery metric, wherein the set of performance categories represent capabilities of the provider evaluated over a range of time periods.

23. The program product of claim 19, wherein the computer program code for enabling the computer infrastructure to obtain a provider delivery metric and a client metric enables the computer infrastructure to obtain a set of performance categories for the client metric, wherein the set of performance categories represent capabilities of the client evaluated over a range of time periods.

24. The program product of claim 23, further comprising computer program code for enabling the computer infrastructure to obtain the set of performance categories from a set of information technology (IT) priorities provided by the client.

25. The program product of claim 24, further comprising computer program code for enabling the computer infrastructure to obtain the set of information technology (IT) priorities from the client based on a set of business priorities for the client.

26. A method of generating a system for managing a business engagement, the method comprising:
providing a computer infrastructure operable to:
obtain a provider delivery metric and a client metric;
obtain a resulting metric that identifies a set of resulting elements relevant to a provider and a client, wherein the resulting metric is based on the provider delivery metric and the client metric;
obtain an advantage value for each of the set of resulting elements; and
select at least one of the set of resulting elements to be included in the business engagement, wherein the selection is based on the advantage value.
